(19) United States
(12) Patent Application Publication
(10) Pub. No.: US 2026/0167566 A1
(43) Pub. Date: Jun. 18, 2026

(54) Dry Cast Concrete with Lower Global Warming Potential Through Carbon Sequestration

(71) Applicants: Meimanat Soleimanifar, North Vancouver (CA); Meghdad Hoseini, North Vancouver (CA); Sadegh Kazemi, North Vancouver (CA)

(72) Inventors: Meimanat Soleimanifar, North Vancouver (CA); Meghdad Hoseini, North Vancouver (CA); Sadegh Kazemi, North Vancouver (CA)

(21) Appl. No.: 19/421,825

(22) Filed: Dec. 16, 2025

Related U.S. Application Data
(60) Provisional application No. 63/735,885, filed on Dec. 18, 2024.
(60) Provisional application No. 63/793,933, filed on Apr. 24, 2025.
(60) Provisional application No. 63/803,537, filed on May 10, 2025.

(51) Int. Cl. C04B 14/02; C04B 7/02; C04B 14/06; C04B 28/04; C04B 40/00

(52) U.S. Cl. CPC C04B 14/022; C04B 7/02; C04B 14/06; C04B 28/04; C04B 40/0032

(57) ABSTRACT

A concrete composition including a binder composition. The binder composition includes solid carbon equal to or more than one percent by mass of the binder composition and supplementary cementitious materials. A method of preparing concrete includes combining solid carbon, Portland cement, and supplementary cementitious materials, in specified proportions to form a binder composition. The specified proportions include solid carbon equal to or more than one percent by mass of the binder composition and supplementary cementitious materials.

### FIELD

The disclosure relates to construction materials and the composite material concrete. More specifically, the disclosure relates to concrete with lower global warming potential (GWP) achieved through sequestration of carbon into concrete mixture.

### BACKGROUND

Concrete is an artificial composite material including aggregates, binders, water, and additives or admixtures. The production of Portland cement, the most common binder in concrete, is a major source of carbon dioxide (CO2), a recognized greenhouse gas (GHG). Thus, the use of traditional concrete as a building material advantageously creates durable material but disadvantageously is a source of GHG emissions.

Portland cement, a type of hydraulic cement, includes CaO, Al₂O₃, Fe₂O₃, MgO, SiO₂, and SO₃. The production of Portland cement, a process called calcination or lime-burning, includes converting limestone (calcium carbonate, CaCO₃) to make quicklime (calcium oxide, CaO) and carbon dioxide (CO₂) as a byproduct. This single chemical reaction is a major source of GHG emissions. This accounting doesn't include the energy needed to raise the temperature required for reactions to approximately 1400° C.

### SUMMARY

This section is intended to introduce certain objectives and aspects of the present disclosure in a simplified manner.

A binder composition including solid carbon equal to or more than one percent by mass of the binder composition, and supplementary cementitious materials.

A concrete composition including a binder composition which includes solid carbon equal to or more than one percent by mass of the binder composition, and supplementary cementitious materials.

A method of preparing a binder composition concrete including combining solid carbon, supplementary cementitious materials, and Portland cement, in specified proportions. The solid carbon is equal to or in excess of one percent by mass of the binder composition.

A method of preparing a binder composition for use in concrete, the method including combining solid carbon, supplementary cementitious materials, and Portland cement, in specified proportions to form the binder composition. The specified proportions include solid carbon equal to or in excess of one percent by mass of the binder composition.

A system, device, article, composition of matter, or method as described herein.

This summary does not necessarily describe the entire scope of all aspects. Other aspects, features, and advantages will be apparent to those of ordinary skill in the art upon review of the following description of specific embodiments.

### BRIEF DESCRIPTION OF DRAWINGS

Systems, devices, articles, and methods are described in greater detail herein with reference to the following figures in which.

FIG. 1 is a schematic view of a concrete plant used to produce dry-cast concrete products.

FIG. 2 is a flowchart illustrating a method of operation of the concrete plant.

FIG. 3 is a plot illustrating one or more binder compositions.

FIG. 4, FIG. 5, FIG. 6, and FIG. 7 include charts illustrating the strength of a plurality of concrete mixes in accordance with certain aspects of the disclosure.

FIG. 8 is a plot illustrating one or more binder compositions including some binders used in the plurality of concrete mixes described in FIG. 7.

The above-mentioned drawings illustrate exemplary embodiments of the disclosed methods and systems in which like reference numerals refer to the same parts throughout the different drawings. Components in the drawings are not necessarily to scale; emphasis instead being placed upon clearly illustrating the principles of the present invention. Some drawings may indicate the components using block diagrams and may not represent the internal circuitry of each component. Also, the embodiments shown in the figures are not to be construed as limiting the disclosure but only as illustrative examples.

### DETAILED DESCRIPTION OF THE INVENTION

In the following description, associated drawings, included claims, and other parts of the document, various details are set forth to provide a detailed understanding of the disclosure and embodiments thereof. It will be apparent, however, that the disclosed embodiments may be practiced without these details. Several features described hereafter can each be used independently of one another or with any combination of other features.

In view of the above-mentioned problems and challenges, the Applicant appreciates there is a need for advanced concrete formulations and production methods with lower global warming potential (GWP) than traditional concrete. Unlike traditional dry cast concrete formulations that rely on Portland cement, which contributes significantly to carbon emissions, the present disclosure integrates solid carbon materials, supplementary cementitious material (SCM), or carbon dioxide sequestration techniques to lower the global warming potential (GWP) of construction material while maintaining suitable performance, e.g., structural integrity.

Unlike traditional concrete, which relies on energy-intensive processes, this disclosure shows sequestering carbon, for example solid carbon (fine or coarse) from a process such as methane pyrolysis (MP), and/or utilizing other byproducts of SCM materials. Concrete with lower GWP include concrete compositions incorporating carbon-based material from various sources, including MP and direct air capture (DAC) processes. The carbon material may include solid carbon of various sizes and forms. These concrete compositions sequester carbon, reduce GHG emissions, and meet stringent industry standards for concrete quality.

Applicant appreciates that the solid carbon byproduct of MP may be used in concrete compositions. MP, a process that thermally decomposes methane into hydrogen gas and solid carbon, offers a CO₂ emission-free pathway to produce hydrogen. With adoption of MP technology, substantial quantities of solid carbon (e.g., carbon black) will become available. Landfilling is not a suitable method of solid carbon sequestration. Applicant proposes permanent carbon sequestration in concrete, preventing release as CO₂ and reducing GHG emissions. Additionally, identifying applications for solid carbon enhances economic viability by converting it into valuable products, such as construction materials, which can substantially reduce hydrogen production costs. Finally, incorporating solid carbon aligns with circular economy principles, reducing reliance on virgin resources.

Applicant has observed that sequestering carbon in concrete can improve or does not have a significant adverse impact on the mechanical and physical properties of the concrete, while significantly contributing to the development of mixes of concrete with low GWP or even carbon-negative concrete mixes.

The term “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise. The term “and/or” herein when used in association with a list of items means any one or more of the items comprising that list.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled or coupling can indicate that two units or devices are directly connected to one another or connected to one another through one or more intermediate elements or devices by a conduit, fluid passage, electrical element, electrical signal, mechanical element, or body depending on the particular context.

“Portland cement” herein refers to a binder, a hydraulic cement, including CaO, Al₂O₃, Fe₂O₃, MgO, SiO₂, and SO₃.

“Fine aggregate” herein refers to small-sized particles that contribute workable concrete mix and smooth finish. These particles typically have a diameter of less than five (5) mm and may be smaller than one (1) mm. Examples include sand such as natural sand, manufactured sand; crushed stone sand; or stone dust.

“Coarse aggregate” herein refers to granular materials used in concrete comprising particles range in size from five (5) mm to forty (40) mm and more typically range in size from five (5) mm to ten (10) mm in dry cast concrete. Coarse aggregates often appear in types such as crushed stone, produced by crushing hard rocks like granite or limestone; crushed concrete; or gravel, a naturally occurring material that is more rounded.

“Supplementary cementitious materials” (SCMs) are materials used in conjunction with Portland cement to enhance the properties of concrete. They can be added to concrete mixtures to improve durability, decrease permeability, and enhance overall performance through pozzolanic activity. Examples of SCMs include fly ash, silica fume, slag or ground granulated blast furnace slag (GGBFS), organic matter ash, and natural pozzolans. Fly ash is a byproduct of coal combustion. GGBFS is a glassy composition created in ironmaking and steel-making processes. Silica fume is a byproduct of the production of silicon and ferrosilicon alloys. Natural pozzolans are earths like calcined clays and shales that react with calcium hydroxide to form compounds with cementitious properties. Organic matter ash, rich in silica like rice husk ash, may be used as an SCM.

Solid carbon herein refers to carbon in a solid state and includes carbon black, coarse carbon, nano carbon, nano fiber carbon, micro carbon, or graphite. Carbon black is a fine black powder, typically ranges from 10 to 500 nanometers, made primarily of elemental carbon produced by the incomplete combustion of heavy petroleum products, such as tar and ethylene cracking tar. Coarse carbon, also known as activated charcoal, typically ranges from 100-1000 micrometers is a form of carbon that has been processed to have small, low-volume pores that increase the surface area available for adsorption or chemical reactions. Methane pyrolysis may produce carbon similar in size and structure to carbon black or activated charcoal. Graphite is a crystalline allotrope of carbon which includes nano fiber carbon, nano carbon, and micro carbon. Graphite may be a byproduct of Methane pyrolysis, Kvorner process, or the like. Suitable graphite includes particles in the range from 10-100 micrometers.

Nano Fiber Carbon (NFC) refers to carbon in a solid state with particle sizes characterized by diameters in the range from 10-100 nanometers and length of 1-5 microns. NFC may be a product of CO₂ (from direct air captured) processed from methane. In shape, NFC can be elongate, conical, plate-like, or cup-like. Nano Carbon (NC) refers to carbon in a solid state with particle sizes characterized by diameters in the range from 50 to 350 nanometers and may include carbon black. Micro Carbon (MC) refers to carbon in a solid state with particles having characteristic dimensions in a range from 950 nanometers to 1000 micrometers, such as coarse carbon.

An efflorescence admixture or reducer is a special additive used in concrete and building products to reduce efflorescence, the white powdery water-soluble salts that can form on the surface of concrete and masonry. An efflorescence admixture binding the salt-based impurities in the concrete or disrupts the migration of soluble salts within the pore structure of the concrete.

Global Warming Potential (GWP) refers to the total greenhouse gas emissions associated with the production of concrete, expressed as the equivalent amount of carbon dioxide (CO₂e) per unit of concrete (e.g., per cubic meter).

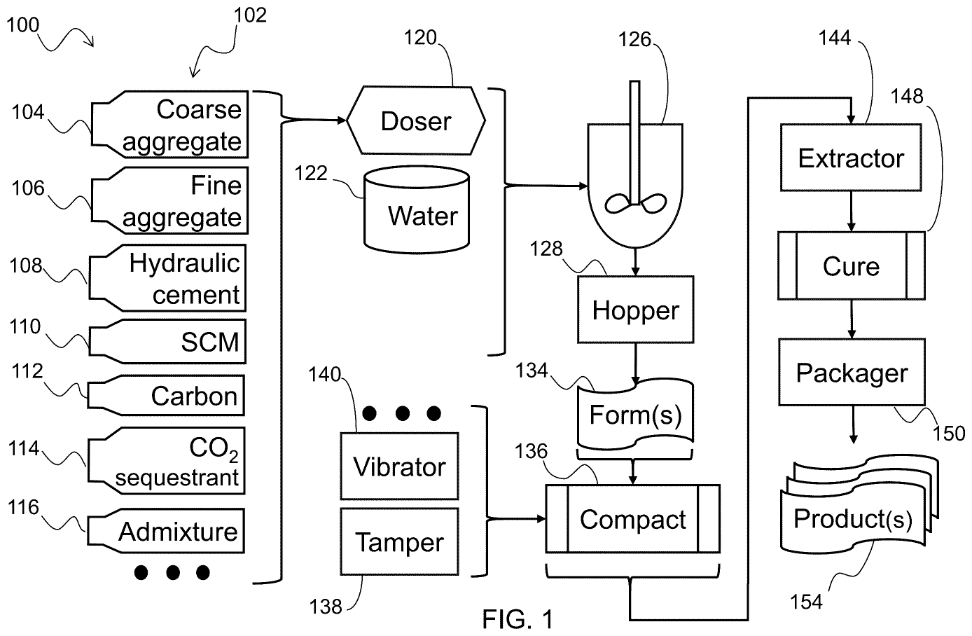

Referring now to FIG. 1 which illustrates a schematic of an exemplary concrete plant 100 including examples of devices and methods used in the manufacture of a building product.

Plant 100 includes a plurality of input dry materials 102 such as coarse aggregate 104, fine aggregate 106, hydraulic cement 108, supplementary cementitious materials (SCM) 110, carbon 112, CO2 sequestrant(s) 114, and admixture(s) 116. Examples of carbon 112 include examples described herein including carbon black, coarse carbon, nano carbon, nano fiber carbon, micro carbon, or graphite. Examples of CO₂ sequestrants 114 include magnesium carbonate (MgCO₃) or sodium carbonate (Na₂CO₃). Examples of admixtures include air entrainers, compaction aids, efflorescence reducers, pigments, plasticizers, set accelerators, water repellant additives, viscosity modifiers, or the like.

Plant 100 includes a batcher, dosing unit, or doser 120 that combines the plurality of input dry materials, and a mixer 126 that accepts the output of doser 120 and other input material such as water 122 or admixture(s) 116. In some examples, doser 120 is coupled to mixer 126 by a conveyor belt. Examples of mixer 126 include a Techmatik SPMW-500 Planetary Mixer by Columbia Machine Radom, PL-14, PL.

In operation, plant 100 transfers the content or mix in mixer 126 to a hopper 128 (optional) and then into one or more forms 134. Form(s) 134 define, in part, the shape of a concrete product and may include positive elements (e.g., buck, pattern, plug) in addition to negative elements defined by the inner surface of form(s) 134. The form(s) 134 may be placed on a palette, cookie sheet, or plate collectively plate, and, in some embodiments, the plate forms part of the inner surface of form(s) 134.

In some embodiments, plant 100 includes one or more compactors that, in response to control signals, compact the mix in form(s) 134. As shown, plant 100 includes a compact method 136. Examples of compactors include vibrators and tampers, such as, tamper 138 and vibrator 140. The one or more compactors may be part of a material handling system.

In some embodiments, plant 100 includes one or more extractors 144 that in response to control signals removes the concrete from form(s) 134. The one or more extractors 144 may be part of a material handling system. The material handling system may include an accumulator to transfer pallet and form(s) 134 within plant 100. Examples of an accumulator include a TIGER Robotic Pallet Accumulator. Plant 100 may include a transporter such as a TIGER Pallet Transporter System. TIGER products are sold by Pathfinder of Holland, MI, US. In some embodiments, plant 100 includes a stacker-destacker. In some embodiments, the material handling system includes pneumatic, electric, hydraulic or combined operations.

In operation, the concrete is hardened in a cure method 148. The times used in cure method 148 vary with environmental conditions (e.g., temperature and humidity), composition (e.g., cement, SCM, and water content), and application. The concrete starts to harden within 2 to 4 hours after being cast. After about 8 to 48 hours, the concrete can be handled and moved without causing damage. Cure method 148 includes processes that allow the concrete to cure or reach desired strength and durability.

In some embodiments, plant 100 includes a packager 150 that assembles and dresses one or more concrete products. For example, palletizing pavers, or cubing pavers.

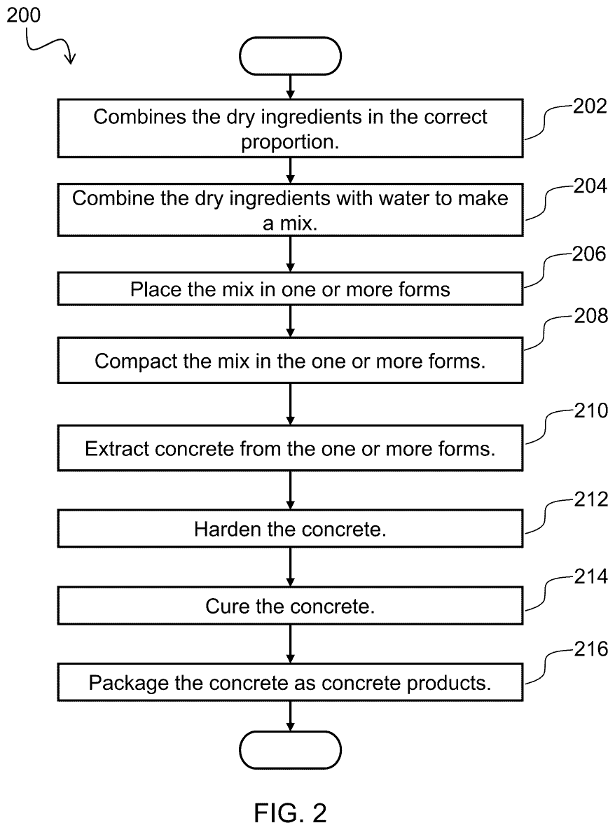

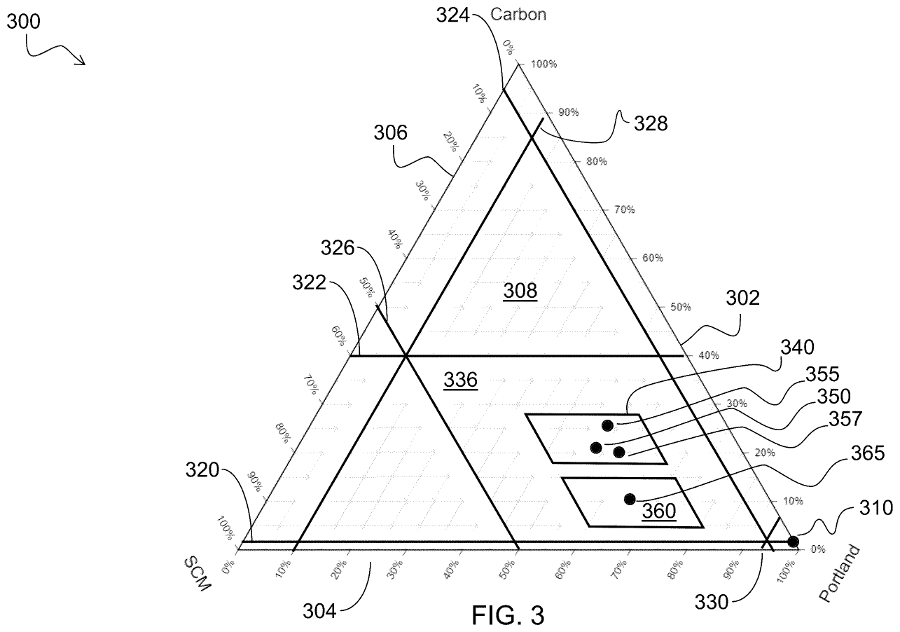

Referring now to FIG. 2, which illustrates a flowchart an exemplary method 200 for making a building product. Method 200 may be performed by a concrete plant such as plant 100.

At 202, the plant combines the dry ingredients in the correct proportion. In some embodiments, batcher 120 combines the dry ingredients selected from dry ingredients 102. The dry ingredients are measured and mixed examples of dry ingredients include aggregate, sand, binder, and additives. One or more of each type of dry ingredient may be included at 202.

In some embodiments, at 202, the plant combines a plurality of binders into a binder composition including Portland cement, solid carbon, and SCM, in specific proportions to form a binder composition. The specified proportions include solid carbon equal to or more than one percent by mass of the binder composition, and SCM. In some embodiments, the solid carbon is carbon black, coarse carbon, nano carbon, nano fiber carbon, micro carbon, or graphite.

In some embodiments, at 202, the plant combines a plurality of binders into a binder composition including solid carbon in a range between one (1) percent and thirty (30) percent mass of the binder composition. In some embodiments, at 202, the plant combines a plurality of binders into a binder composition including SCM in a range between five (5) percent and forty (40) percent mass of the binder composition. At 202, in some embodiments, the binder composition includes Portland cement in the range of thirty (30) to ninety-four (94) percent by mass of the binder composition.

At 204, the plant combines the dry ingredients with water. For example, mixer 126 combines the output of doser 120 and water from storage tank 124. In embodiments where the concrete is dry cast the mixture has a low or very low water-to-binder ratio, in a range such as 0.18 to 0.38, 0.20-0.35, 0.20-0.24, or 0.28-0.32. The dry cast concrete mixture comprises binder, fine aggregate, coarse aggregate, water, and admixtures. This low water content results in a zero-slump mix, which characterizes a dry cast process.

At 206, the plant places the mix in one or more forms. For example, the mix from mixer 126 is placed in one or more forms 134. In some embodiments, a hopper, e.g., hopper 130, is used to place the mix in form(s) 134. The forms may be rigid. Due to the mix having a low water content, the mix resembles damp soil or clay.

At 208, one or more devices compact the mix. For example, the plant uses vibration. In some embodiments, the one or more forms are coupled to an external shaker or vibrator. In some embodiments, the mix is subjected to mechanical tamping by a press or tamper.

At 210, an extractor removes the concrete from the one or more forms. For example, extractor 144 removes one or more pieces of formed concrete from form(s) 134. In some embodiments, form(s) 134 are lifted leaving one or more pieces of concrete on a rigid planar web or plate.

At 212, the plant hardens the concrete. Hardening is the process where concrete transitions from a plastic state to a solid state. The process begins at 204 and continues through method 200. Typical timelines are tens of minutes to hours. The concrete gains initial strength and becomes firm enough to handle.

At 214, the plant cures the concrete. Several factors influence the curing time, durability, finish, and strength of concrete. Key variables include the batching and casting temperature, batch ingredients, ambient environmental conditions, concrete paver thickness, form configuration, compaction methods (tampering and vibration), and the curing regime. Concrete cures faster in warmer temperatures due to accelerated hydration reactions, but excessive heat can cause water to evaporate too quickly, leading to potential defects. The batch ingredients play a significant role in determining cure time; for instance, the type of binder and admixtures used can alter the rate of hydration. The water-to-cement ratio is another critical factor. A higher ratio may speed up curing but can compromise strength, while a lower ratio enhances durability at the cost of longer curing times. Thicker concrete articles (e.g., products, pavers, or slabs) take more time to cure due to the larger volume of material undergoing hydration. Environmental factors such as wind, humidity, and sunlight also influence the curing process. To optimize curing, the use of curing compounds or sealants can help retain moisture and protect the surface.

At 216, a packager collects or packages the concrete as concrete products. For example, the packager collects and dresses concrete products.

Turning to FIG. 3 which illustrates a ternary plot 300. A ternary plot is a graphical representation of the proportions of three variables that sum to a constant. Plot 300 includes a first axis 302 corresponding to the portion of carbon in a binder composition. A second axis 304 on the bottom corresponds to the portion of Portland cement in the binder composition. A third axis 306 on the left side corresponds to the portion of SCM in the binder composition. Plot 300 includes plot area 308. A location on plot area 308 defines a binder composition. For example, location 310 corresponds to a binder composition including 1 percent carbon and 99 percent Portland cement. Areas and lines in plot area 308 define ranges of values for binder compositions.

In some embodiments, a binder composition includes a portion of carbon at or above one (1) percent shown by line 320. In some embodiments, a binder composition includes a portion of carbon at or below forty (40) percent shown by line 322.

In some embodiments, a binder composition includes a portion of SCM at or above five (5) percent shown by line 324. Increasing values of SCM are below and to the left of line 324. In some embodiments, the amount of SCM in a binder composition increases in proportion to the amount of solid carbon. In some embodiments, a binder composition includes a portion of SCM at or below fifty (50) percent shown by line 326.

In some embodiments, a binder composition includes a portion of Portland cement at or above ten (10) percent shown by line 328. In some embodiments, a binder composition includes a portion of SCM at or below ninety-four (94) percent shown by line 330.

Plot 300 includes one or more regions of interest such as region 336. Region 336 is bounded below by line 320, above by line 322, by SCM content minimum (on right) by line 324, and on the left by line 326. In some embodiments, a binder composition is found in region 336. The corresponding hydraulic cement is constrained by the portions of carbon and SCM.

In some embodiments, a binder composition includes a portion of solid carbon at or above two (2) percent. In some embodiments, a binder composition includes a portion of carbon at or below twenty (20) percent. In some embodiments, a binder composition includes a portion of solid carbon at or above five (5) percent. In some embodiments, a binder composition includes a portion of carbon at or below thirty (30) percent. Horizontal lines on plot 300 and intersecting axis 302 indicate these values.

In some embodiments, a binder composition includes a portion of SCM in a range from ten (10) percent to forty (40) percent. Backslash lines on plot 300 and intersecting axis 306 indicate these values.

In some embodiments, a corresponding portion of hydraulic cement is a range from forty (40) percent to eighty-eight (88) percent. In some embodiments, a corresponding portion of hydraulic cement is a range from thirty (30) percent to eighty-five (85) percent. Forward-slash lines on plot 300 and intersecting axis 304 indicate these values.

Some embodiments include a binder composition in region 340 bounded below by carbon content of at or above seventeen (17) percent and carbon content below thirty-three (33) percent. (Shown.) Some embodiments include a binder composition in region 340 bounded below by carbon content of at or above fifteen (15) percent and carbon content below thirty-five (35) percent. (Not shown.) In some embodiments, region 340 is bounded by SCM content at or above fifteen (15) percent. In some embodiments, region 340 is bounded by SCM content at or below thirty-five (35) percent. The corresponding hydraulic cement is constrained by the portions of carbon and SCM but could be in a range from forty (40) percent to seventy (70) percent.

Some embodiments include a binder composition including solid carbon at about twenty-three (23) percent, SCM at about 26 percent, and Portland cement for principal component of the remainder. Point 350 in region 340 illustrates an example of the binder composition. Point 355 in region 340 illustrates an example of the binder composition comprising solid carbon at about twenty-six (26) percent, SCM at about twenty-two (22) percent, and Portland cement for principal component of the remainder. Some embodiments include a binder composition including solid carbon at about twenty (20) percent, SCM at about twenty-four (24) percent, and Portland cement for principal component of the remainder. Point 355 in region 340 illustrates an example of the binder composition.

Plot 300 includes a region 360. Some embodiments include a binder composition in region 360 bounded below by carbon content of at or above five (5) percent and carbon content below fifteen (15) percent. In some embodiments, region 360 is bounded by SCM content at or above fifteen (15) percent. In some embodiments, region 360 is bounded by SCM content at or below thirty-five (35) percent. The corresponding hydraulic cement is constrained by the portions of carbon and SCM but could be in a range from fifty (50) percent to eighty (80) percent.

Some embodiments include a binder composition including a binder composition comprising solid carbon at about ten (10) percent, SCM at about 23.7 percent, and Portland cement for principal component of the remainder. Point 365 in region 360 illustrates an example of the binder composition.

The present disclosure refers to one or more concrete compositions.

Reference concrete is a concrete with standard levels of aggregate, and 100 percent hydraulic cement with negligible content of carbon or SCM, used as a baseline for comparison. The carbon present in the reference concrete may be used for tinting the colour and in some examples is one percent or less of binders. The values for carbon herein are expressed as proportion to the mass of all binders or just the carbons as will be clear from the context.

In some embodiments, a binder composition includes solid carbon at about ten (10) percent. In some embodiments, the solid carbon includes NFC at about 0.5 percent of the binder composition by mass. In some embodiments, the solid carbon includes NC at about one (1) percent of the binder composition by mass. In some embodiments, the solid carbon includes MC at five (5) percent of the binder composition by mass.

In some embodiments, a binder composition includes fly-ash at about twenty-five (25) percent. In some embodiments, a binder composition includes silica fume at or below ten (10) percent of the binder composition by mass. For example, about 7.5 percent by mass of the binder composition.

Some embodiments of a concrete mixture comprise the following by mass in kilograms shown in the following Table 1. As shown in Table 1, the binder composition includes a binder composition comprising solid carbon at about twenty-three (23) percent, SCM at about 26 percent, and Portland cement for the principal component of the remainder.

TABLE 1

| | Value (Kg) per |
|---|---|
| Mix Component | Cubic Meter |
| Coarse Aggregate | 1168.8 |
| Fine Aggregate | 684.2 |
| Portland cement | 257.1 |
| Fly Ash (FA) | 91.5 |
| Silica Fume (SF) | 36.7 |
| Water | 116.2 |
| Efflorescence Admixture | 0.4 |
| Nano Fiber Carbon | 1.8 |
| (NFC) | |
| Nano Carbon (NC) | 36.7 |
| Micro Carbon (MC) | 76 |

In some embodiments, a binder composition includes, as portion of carbon by mass, twenty (20) percent or more nano carbon, one (1) percent or more NFC, or a minimum of fifty (50) percent of micro carbon. In some embodiments, the SCM includes fly ash and silica fume in a ratio of seventy to thirty.

Some embodiments of a concrete mixture comprise the following by mass in kilograms shown in the following Table 2. As shown in Table 2, the binder composition includes a binder composition comprising solid carbon at about ten (10) percent, SCM at about 24 percent, and Portland cement for the principal component of the remainder.

TABLE 2

| | Value (Kg) per |
|---|---|
| Mix Component | Cubic Meter |
| Coarse Aggregate | 1168.8 |
| Fine Aggregate | 727.2 |
| Portland cement | 257.1 |
| Fly Ash (FA) | 55.1 |
| Silica Fume (SF) | 36.7 |
| Water | 116.2 |
| Efflorescence Admixture | 0.4 |
| Nano Fiber Carbon | 1.3 |
| (NFC) | |
| Nano Carbon (NC) | 18.4 |
| Micro Carbon (MC) | 18.7 |

In some embodiments, a binder composition includes, as portion of carbon by mass, forty (40) percent or more nano carbon, three (3) percent or more NFC, or a minimum of forty (40) percent of micro carbon. In some embodiments, the SCM includes silica fume and fly ash in a ratio of forty to sixty.

Some embodiments of a concrete mixture comprise the following by mass in kilograms, shown in the following Table 3. As shown in Table 3, the binder composition includes a binder composition comprising solid carbon at about twenty-six (26) percent, SCM at about twenty-two (22) percent, and Portland cement for the principal component of the remainder.

TABLE 3

| | Value (Kg) per |
|---|---|
| Mix Component | Cubic Meter |
| Coarse Aggregate | 1168.8 |
| Fine Aggregate | 722.2 |
| Portland cement | 257.1 |
| Fly Ash (FA) | 63.3 |
| Silica Fume (SF) | 42.2 |
| Water | 116.2 |
| Efflorescence Admixture | 0.4 |
| Nano Fiber Carbon | 1.8 |
| (NFC) | |
| Nano Carbon (NC) | 36.7 |
| Micro Carbon (MC) | 76 |

In some embodiments, a binder composition includes, in proportion to total carbon by mass, six (6) percent or more nano carbon, fourteen (14) percent or more NFC, or a minimum of five (5) percent of micro carbon. In some embodiments, the SCM includes fly ash and silica fume in a ratio of sixty to forty.

Some embodiments of a concrete mixture comprise the following by mass in kilograms shown in the following Table 4. As shown in Table 4, the binder composition includes a binder composition comprising solid carbon at about twenty (20) percent, SCM at about twenty-four (24) percent, and Portland cement for the principal component of the remainder.

TABLE 4

| | Value (Kg) per |
|---|---|
| Mix Component | Cubic Meter |
| Coarse Aggregate | 1168.8 |
| Fine Aggregate | 690 |
| Portland cement | 257.1 |
| Fly Ash (FA) | 73.5 |
| Silica Fume (SF) | 36.7 |
| Water | 116.2 |
| Efflorescence Admixture | 0.4 |
| Nano Fiber Carbon | 1.3 |
| (NFC) | |
| Nano Carbon (NC) | 36.7 |
| Micro Carbon (MC) | 56 |

In some embodiments, the concrete mixtures described herein demonstrate a reduced (e.g., substantially reduced) Global Warming Potential (GWP) compared to conventional concrete mixes. GWP is expressed in terms of kilograms of CO2-equivalent (CO₂e) emissions per cubic meter of concrete produced. The reduced GWP is attributable to various factors, including to the partial replacement of Portland cement with supplementary cementitious materials (SCMs) and the inclusion of solid carbon, which both sequester carbon and reduce the reliance on high-emission cementitious binders. Table 5:

| | Reference Mix | | Mix with Low GWP | |
|---|---|---|---|---|
| | Mass | | Mass | |
| Mix Component | (Kg/m³) | GWP | (Kg/m³) | GWP |
| Coarse Aggregate | 1168.8 | 5.8 | 1168.8 | 5.8 |
| Fine Aggregate | 798.2 | 4.0 | 722.2 | 3.6 |
| Portland cement | 401.1 | 280.8 | 257.1 | 180.0 |
| Fly Ash (FA) | 0 | 0.0 | 63.3 | 0.0 |
| Silica Fume (SF) | 0 | 0.0 | 42.2 | 0.0 |
| Water | 116.2 | 0.1 | 116.2 | 0.1 |
| Efflorescence Admixture | 0.4 | 0.8 | 0.4 | 0.8 |
| Nano Fiber Carbon (NFC) | 0 | 0.0 | 1.8 | −5.4 |
| Nano Carbon (NC) | 0 | 0.0 | 36.7 | −110.1 |
| Micro Carbon (MC) | 0 | 0.0 | 76 | −228.0 |

| | | |
|---|---|---|
| GWP (Kg CO₂/m³ of | 291.5 | −153.2 |
| concrete) | | |

In some embodiments, a binder composition includes, in proportion of carbon by mass, thirty-five (35) percent or more nano carbon, one (1) percent or more NFC, or a minimum of ten (10) percent of micro carbon. In some embodiments, the SCM includes silica fume and fly ash in a ratio of two to one.

In some embodiments, the concrete composition includes twenty (20) percent or more nano carbon, seven and a half (7.5) percent coarse carbon, or a minimum of ten (10) percent of both. In some embodiments, the concrete composition includes about twenty-five (25) percent SCM.

In some embodiments, the concrete composition includes nano carbon in a range from one (1) to twenty-five (25) percent of binder mass. In some examples, the nano carbon includes carbon black.

In some embodiments, the concrete composition includes coarse carbon in a range from one (1) to ten (10) percent. In some examples, the coarse carbon includes activated carbon.

In some embodiments, a binder composition includes carbon and SCM in a range from fifteen (15) to twenty-five (25) percent. In some examples, the SCM includes silica fume and fly ash.

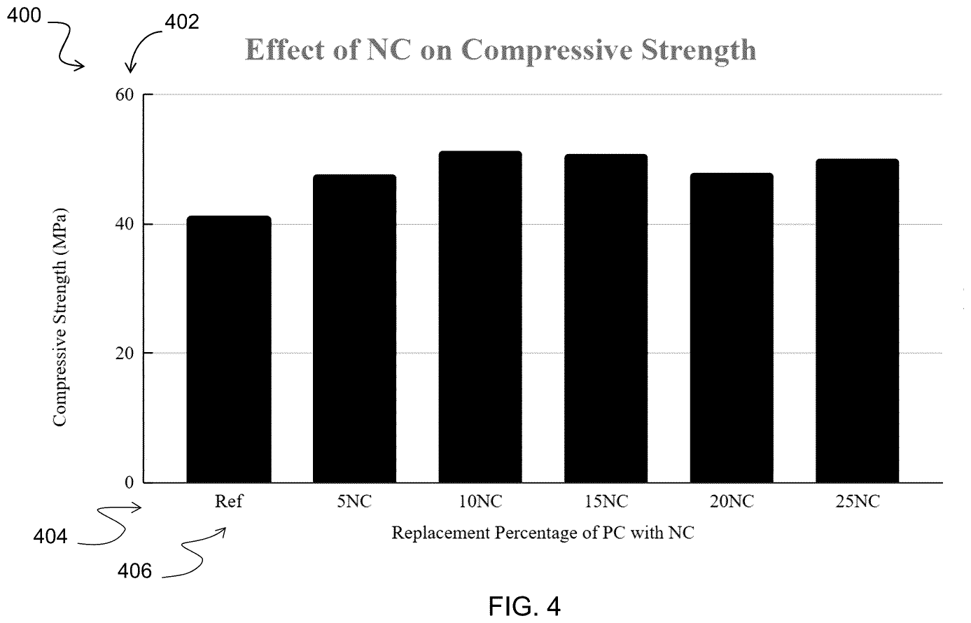

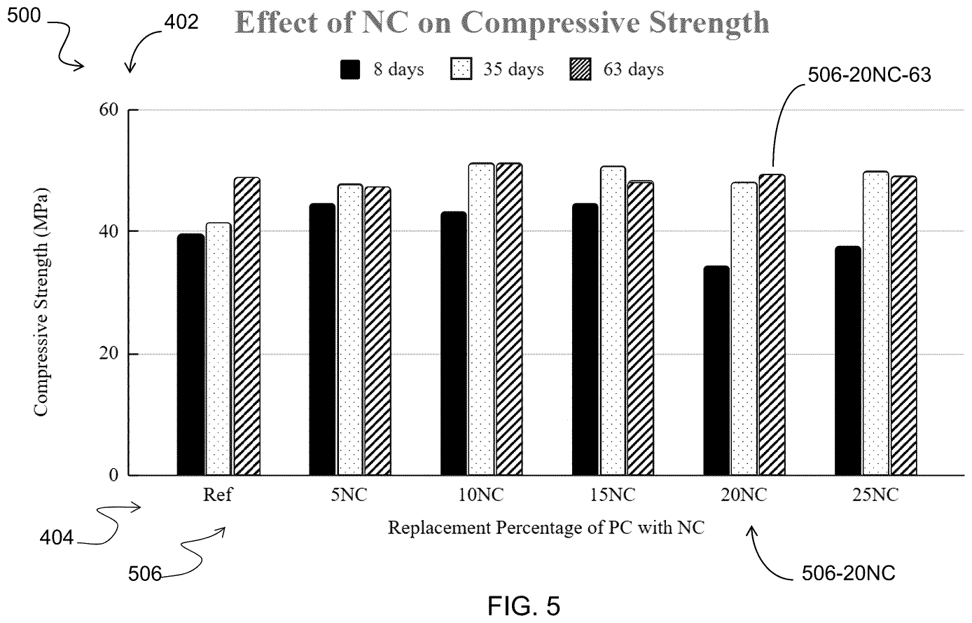

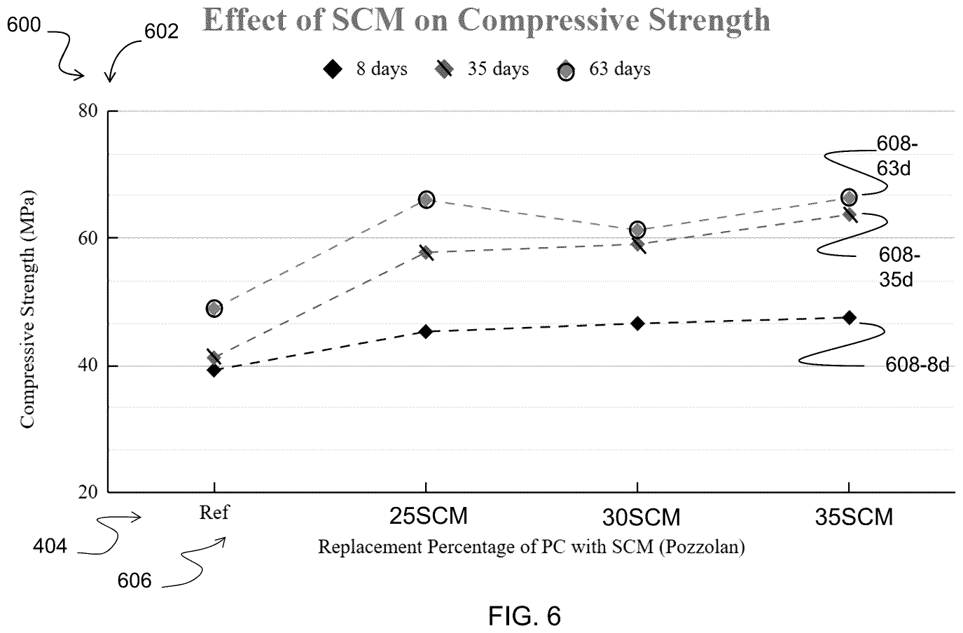

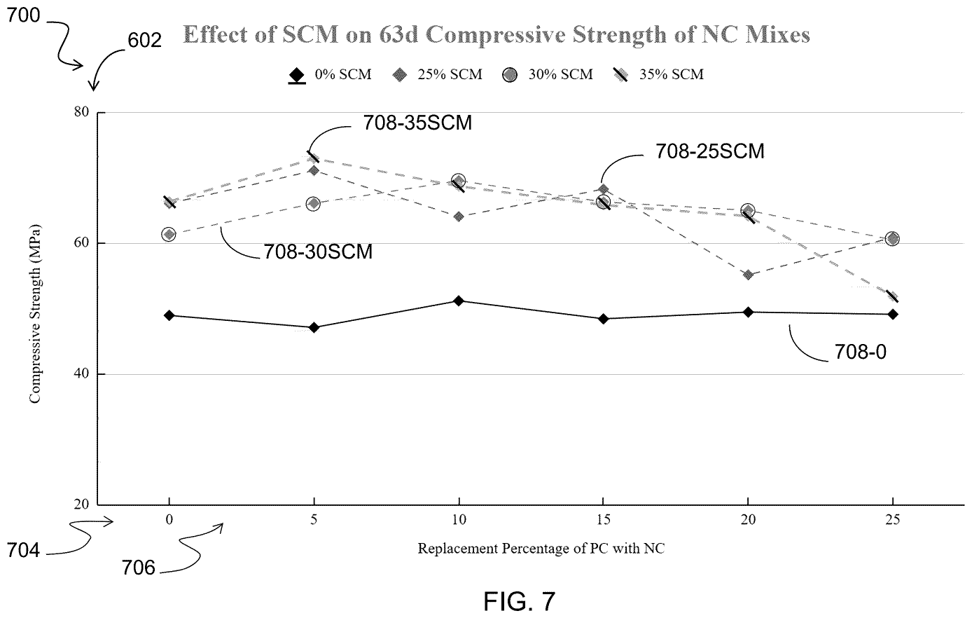

Turning to FIG. 4, which includes a chart 400 illustrating the compressive strength of a plurality of concrete mixes. Chart 400 includes a first axis 402 against which is plotted the compressive strength with units of force (e.g., MPa). Chart 400 further includes a second axis 404 for a dimension 406. For example, dimension 406 includes dimension members corresponding to different mixes. For example, member 406-Ref corresponds to a reference concrete with Portland cement as a binder. Exemplary members 406-5NC, 406-10NC, 406-15NC, 406-20NC, and 406-25NC correspond to concrete mixes where an amount of Portland cement is replaced with a corresponding amount of nano-carbon according to each respective label. There is a gain in strength with added NC and this a flat profile across chart 400. The concrete mixes corresponding to members 406-5NC, 406-10NC, 406-15NC, 406-20NC, and 406-25NC have greater compressive strength compared to the reference concrete mix.

The condition used to generate chart 400 included 35 days (5 weeks) cure time. The compressive strength of samples of the cured concrete mixes was tested using the ASTM C39/C39M standard. Cylindrical concrete specimens were cast and cured for varying time and then subjected to a compressive axial load. The specimen and load are monitored, and the point of failure is the recorded value shown in FIG. 4 and other drawings herein.

Turning to FIG. 5, which includes a chart 500 illustrating the compressive strength of a plurality of concrete mixes in view of nanocarbon content and cure time. In chart 500 the compressive strength is plotted against first axis 402, and second axis 404 includes a hierarchical dimension 506. Each first order member of dimension 506 is corresponds to a NC replacement percentage and is split into a plurality of members corresponding to cure times—8 days, 35 days, and 63 days. Leaf members include members 506-Ref-08, 506-Ref-35, 506-Ref-63, 506-5NC-08, 506-5NC-35, . . . and 506-25NC-63. That is, in chart 500, dimension 506 is a hierarchy including cure time stacked on replacement percentage.

Generally, there is a gain in strength with cure time. However, certain concrete mixes corresponding to 63 days of cure (that is, member 506-5NC-63, member 506-15NC-63, and member 506-25NC-63) are weaker than their 35-day counterparts. However, these concrete mixes are never weaker than the reference concrete mixes (e.g., see member 506-Ref-63) and are comparable to the counterparts cured for 35 days.

Turning to FIG. 6, which includes a chart 600 illustrating the compressive strength of a plurality of concrete mixes in view of SCM content and cure time. In chart 600, the compressive strength is plotted against a first axis 602 and a second axis 604, which includes a dimension 606. The members of dimension 606 include 606-Ref, 606-25SCM, 606-30SCM, and 606-35SCM correspond to a concrete mix where a corresponding amount of Portland cement is replaced by SCM—e.g., a Pozzolan.

Chart 600 includes a plurality of series 608 where the abscissae are members of dimension 606 and the measure value is plotted against first axis 606. The plurality of series 608 includes series 608-8d, 608-35d, and 608-63d. Generally, compressive strength increases with cure time and SCM content.

Turning to FIG. 7, which includes a chart 700 illustrating the compressive strength of a plurality of concrete mixes in view of SCM content, and NC content. The data in chart 700 is for a cure-time of 63 days (9 weeks). In chart 700 the compressive strength is plotted against a first axis 602 and for a second axis 704 which includes a dimension 706. The members of dimension 706 include 706-5NC, 706-10NC, 706-15NC, 706-20NC, and 706-25NC correspond to a concrete mix were a corresponding amount of Portland cement replaced by NC.

Chart 700 include a plurality of series 708 where the abscissae are members of dimension 706. The plurality of series 708 includes series 708-OSCM, 708-25SCM, 708-30SCM, and 708-35SCM. Generally compressive strength increases with SCM content. There are some exceptions in that 25SCM is comparable to 35SCM with some carbon values.

Generally compressive strength is weakly affected by moderate levels of nanocarbon in the binder. That is, the series 708 are generally flat. There is one exception in that 25SCM-20NC is weaker than adjacent test mixes (e.g., is comparable to 35SCM with the same carbon values).

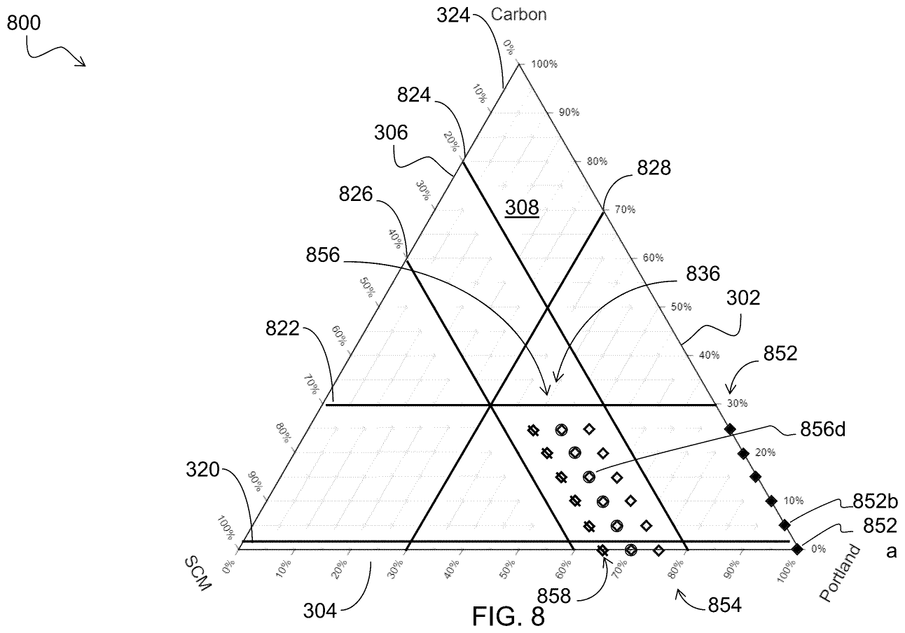

Turning to FIG. 8, which illustrates a ternary plot 800 illustrating summaries of the compositions of binders including binders for concrete mixes described in relation to, at least, FIG. 7. Plot 800 includes first axis 302 (showing the share of carbon in the binder), second axis 304 (Portland cement), and third axis 306 (SCM) defining plot area 308. A location on plot area 308 defines a binder composition. For details and further examples, see FIG. 4.

In some embodiments, a binder composition includes a portion of carbon at or above one (1) percent, shown by line 320. In some embodiments, a binder composition includes a portion of carbon at or below thirty (30) percent, shown by line 822.

In some embodiments, a binder composition includes a portion of SCM at or above twenty (20) percent shown by line 824. In some embodiments, a binder composition includes a portion of SCM at or below forty (40) percent, shown by line 826.

In some embodiments, a binder composition includes a portion of Portland cement at or above thirty (30) percent shown by line 828. The maximum for Portland cement is constrained by the portions of carbon and SCM.

Plot 800 includes one or more regions of interest such as region 836. Region 836 is bounded below by line 320, above by line 822, by SCM content minimum (on right) by line 824, and on left by line 826. The corresponding, hydraulic cement is constrained by the portions of carbon and SCM. In some embodiments, a binder composition is found in region 836.

Plot 800 includes a plurality of plurality of points. Each point corresponds to a binder composition used in a concrete mix. Test data for each concrete mix are described herein in relation to at least FIG. 4 and FIG. 7. Plurality of points 852 including point 852a, point 852b, and so on, are for binder compositions with no SCM and varying amounts of nanocarbon as shown. Plurality of points 852 corresponds to series 708-OSCM shown in FIG. 7.

Plot 800 further includes a plurality of points 854. Each point in the plurality of points 854 corresponds to a binder composition with 25 percent SCM and varying amounts of Portland cement and nanocarbon, as plotted. Plurality of points 854 corresponds to series 708-25SCM shown in FIG. 7. Plurality of points 854 includes point 854d which has high compressive strength moderate NC content (15 percent) and the lowest of the non-trivial SCM content tested.

Plot 800 further includes plurality of points 856 where each point in plurality of points 856 corresponds to a binder composition with thirty (30) percent SCM and varying amounts of Portland cement and nanocarbon, as plotted. Plurality of points 856 corresponds to series 708-30SCM shown in FIG. 7.

Plot 800 further includes plurality of points 858 where each point in plurality of points 858 corresponds to a binder composition with thirty-five (35) percent SCM and varying amounts of Portland cement and nanocarbon, as shown. Plurality of points 858 corresponds to series 708-35SCM shown in FIG. 7.

Each document cited herein was cited to provide clarity to the reader and is incorporated by reference in its entirety. In cases where the present disclosure conflicts with a document incorporated by reference, the present disclosure controls.

To the extent that they are not inconsistent with the specific teachings and definitions herein, all of the U.S. patents, U.S. patent application publications, U.S. patent applications, foreign patents, and foreign patent applications referred to in this specification and/or listed in the Application Data Sheet, including but not limited to any cross-referenced application or priority claim are incorporated herein by reference, in their entirety.

While the disclosure has been described in connection with specific embodiments, it is to be understood that the disclosure is not limited to these embodiments and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

The above description illustrates various embodiments of the present disclosure along with examples of how aspects of particular embodiments may be implemented. The above examples should not be deemed to be the only embodiments or implementations and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

1. A concrete composition comprising:
a binder composition including:
solid carbon equal to or more than one percent by mass of the binder composition, and
supplementary cementitious materials.

2. The composition of claim 1 further comprising:
aggregates
sand; and
water.

3. The composition of claim 1, wherein the solid carbon is selected from the group consisting of carbon black, coarse carbon, nano carbon, nano fiber carbon, micro carbon, or graphite.

4. The composition of claim 1, wherein the binder composition comprises solid carbon in the range of one percent to forty percent by mass of the binder composition.

5. The composition of claim 1, wherein the binder composition comprises supplementary cementitious materials in the range of five percent to fifty percent by mass of the binder composition.

6. The composition of claim 1 further comprising Portland cement.

7. The composition of claim 6, wherein the binder composition comprises Portland cement in the range of ten percent to ninety-four percent by mass of the binder composition.

8. A method of preparing a binder composition for use in concrete, the method comprising:
combining Portland cement, solid carbon, and supplementary cementitious materials, in specified proportions to form the binder composition; and
wherein the specified proportions include:
solid carbon equal to or in excess of one percent by mass of the binder composition, and
supplementary cementitious materials.

9. The method of claim 8 further comprising:
mixing the binder composition with fine aggregates and coarse aggregates;
mixing the binder with water, and to form an uncured mixture.

10. The method of claim 8 further comprising curing the uncured mixture.

11. The method of claim 8, wherein the solid carbon is selected from the group consisting of carbon black, coarse carbon, nano carbon, nano fiber carbon, micro carbon, or graphite.

12. The method of claim 8, wherein the binder composite comprises solid carbon in the range of one percent to forty percent by mass of the binder composition.

13. The method of claim 8, wherein the binder composition comprises supplementary cementitious materials in range of five percent to fifty percent by mass.

14. The method of claim 8, wherein the binder composition further comprises:
Portland cement, and
wherein the binder composition comprises Portland cement in the range of ten percent ninety-four percent by mass of the binder composition.
